(19) United States
(12) Patent Application Publication
(10) Pub. No.: US 2020/0088926 A1
(43) Pub. Date: Mar. 19, 2020

(54) RETARDATION FILM, DISPLAY DEVICE COMPRISING SAME, AND COATING COMPOSITION FOR SAME

(71) Applicant: SAMSUNG ELECTRONICS CO., LTD., Suwon-si (KR)

(72) Inventors: Ha Na KIM, Yongin-si (KR); Hyunseok CHOI, Seoul (KR); Sangah GAM, Seoul (KR); Ju Hyun KIM, Anyang-si (KR)

(21) Appl. No.: 16/275,710

(22) Filed: Feb. 14, 2019

(30) Foreign Application Priority Data
Sep. 18, 2018 (KR) 10-2018-0111650

(51) Int. Cl. G02B 5/30; G02F 1/13363; G02F 1/13357

(52) U.S. Cl. CPC G02B 5/3083; G02F 1/13363; G02F 2001/133614; G02F 2202/022; G02F 1/1336

(57) ABSTRACT

A retardation film including a retardation coating layer including a polyimide and a solvent, wherein the solvent has a vapor pressure of less than about 15 Torr at 20° C. and a solubility parameter satisfying Relationship Formula 1.

16≤\sqrt{δ_{D}²+δ_{P}²+δ_{H}²}<20 [Relationship Equation 1]

### CROSS-REFERENCE TO RELATED APPLICATION

This application claims priority to and the benefit of Korean Patent Application No. 10-2018-0111650 filed in the Korean Intellectual Property Office on Sep. 18, 2018, the content of which is incorporated herein by reference in its entirety.

### BACKGROUND

### 1. Field

A retardation film, a liquid crystal display device comprising the retardation film, and a liquid coating composition for preparing the retardation film are disclosed.

### 2. Description of the Related Art

A flat panel display device may be classified as a light-emitting display device capable of emitting light by itself, i.e., without the need for a separate light source, or a non-emissive display device having a separate light source. A retardation film is frequently employed for improving the image quality of the flat panel display device. The retardation film is used to realize a predetermined phase difference by elongating, for example, a polymer film in a uniaxial or biaxial direction.

However, there remains a need for a retardation film for a flat panel display, having a thin thickness and improved properties.

### SUMMARY

An embodiment provides a retardation film capable of preventing decrease in the visibility and compensation characteristics of a liquid crystal display, by improving the coating properties of a solution used to prepare the retardation film.

Another embodiment provides a display device includes the retardation film.

Yet another embodiment provides a liquid crystal display (LCD) including the retardation film as an in-cell film.

Still another embodiment provides a liquid coating composition (coating liquid) for the manufacture of the retardation film.

According to an embodiment, a retardation film includes a retardation coating layer including a polyimide and a solvent, wherein the solvent has a vapor pressure of less than about 15 Torr at 20° C. and a solubility parameter satisfying Relationship Formula 1.

16≤\sqrt{δ_{D}²+δ_{P}²+δ_{H}²}<20 [Relationship Formula 1]

In Relationship Formula 1,

δ_{D} is a Hansen solubility parameter of a non-polar dispersion bond of the solvent,

δ_{P} is a Hansen solubility parameter of a polar bond of the solvent, and

δ_{H} is a Hansen solubility parameter of a hydrogen bond of the solvent.

The solvent may have a solubility parameter satisfying Relationship Formula 2.

0<|δ_{P}−δ_{H}|≤4.5 [Relationship Equation 2]

In Relationship Formula 2,

δ_{P} is a Hansen solubility parameter of a polar bond of the solvent, and

δ_{H} is a Hansen solubility parameter of a hydrogen bond of the solvent.

The solvent may have a solubility parameter satisfying Relationship Formula 3.

9.5≤|δ_{D}−δ_{P}|≤15 [Relationship Equation 3]

### In Relationship Formula 3,

δ_{D} is a Hansen solubility parameter of a non-polar dispersion bond of the solvent, and

δ_{P} is a Hansen solubility parameter of a polar bond of the solvent.

The solvent may have a solubility parameter satisfying Relationship Formula 4.

5.0≤|δ_{D}−δ_{H}|≤15 [Relationship Equation 4]

In Relationship Formula 4,

δ_{D} is a Hansen solubility parameter of a non-polar dispersion bond of the solvent, and

δ_{H} is a Hansen solubility parameter of a hydrogen bond of the solvent.

The solvent may have a vapor pressure of about 3 Torr to about 10 Torr (@20° C.).

A thickness deviation of the retardation coating layer may be less than or equal to about 10 nanometers (nm) and a wavelength deviation of the retardation coating layer may be less than or equal to about 3 nm.

A thickness of the retardation coating layer may be less than or equal to about 5 micrometers (μm).

According to another embodiment, a display device including the retardation film is provided.

According to another embodiment, a liquid crystal display (LCD) includes a light source and a liquid crystal display panel, wherein the liquid crystal display panel includes a first substrate disposed on the light source, a second substrate facing the first substrate, a liquid crystal layer between the first substrate and the second substrate, and a retardation coating layer disposed between the second substrate and the liquid crystal layer, and including polyimide and a solvent, wherein the solvent has a vapor pressure of less than about 15 Torr at 20° C. and a solubility parameter satisfying Relationship Formula 1.

The solvent may have the solubility parameter satisfying Relationship Formula 2.

The solvent may have the solubility parameter satisfying Relationship Formula 3.

The solvent may have the solubility parameter satisfying Relationship Formula 4.

The solvent may have a vapor pressure of about 3 Torr to about 10 Torr at 20° C.

A thickness deviation of the retardation coating layer may be less than or equal to about 10 nm and a wavelength deviation of the retardation coating layer may be less than or equal to about 3 nm.

A thickness of the retardation coating layer may be less than or equal to about 5 μm.

The liquid crystal display (LCD) may further include a polarization layer disposed on or under the retardation coating layer.

The liquid crystal display (LCD) may further include a color conversion layer on an upper surface of the retardation coating layer, and the color conversion layer may include a light emitting element configured to receive first visible light from the light source and to emit second visible light having the same wavelength as the first visible light or a longer wavelength than the first visible light.

According to another embodiment, a liquid coating composition includes polyimide and a solvent, wherein the solvent has a vapor pressure of less than about 15 Torr at 20° C. and a solubility parameter satisfying Relationship Formula 1.

The solvent may have a solubility parameter satisfying Relationship Formulae 3, 4, and 5.

The polyimide may be present in an amount of about 3 weight percent (wt %) to about 30 wt %, based on a total weight of the liquid coating composition.

Coating properties of the solution for a retardation coating layer is improved to prevent decrease of visibility and compensation characteristics.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is a schematic cross-sectional view of a display device according to an embodiment;

FIG. 2 is a schematic cross-sectional view of an organic light emitting display device according to an embodiment;

FIG. 3 is a schematic cross-sectional view of a liquid crystal display device according to another embodiment;

FIG. 4 is a schematic view showing an example of a method for confirming the presence of reflection spots in the retardations films according to the Preparation Examples and Comparative Preparation Examples;

FIG. 5 is a photographic image showing the result of a spot test conducted by reflection of the retardation film prepared according to Preparation Example 1;

FIG. 6 is a photographic image showing the result of a spot test conducted by reflection of the retardation film according to Comparative Preparation Example 1; and

FIG. 7 is a photographic image showing the result of a spot test conducted by reflection of the retardation film according to Comparative Preparation Example 6.

### DETAILED DESCRIPTION

Hereinafter, embodiments will hereinafter be described in detail so that a person skilled in the art would understand. However, embodiments may be embodied in many different forms and is not construed as limited to the embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, “a first element,” “component,” “region,” “layer” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, when a definition is not otherwise provided, “substituted” refers to a compound or group substituted with at least one substituent independently selected from a halogen atom (F, Br, Cl, or I), a hydroxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, and a combination thereof.

A retardation film prepared by a coating-type method, rather than by elongation of a polymer film, has been investigated. Since the retardation film is formed by coating a solution on a substrate, the process may be easy and may be used to provide a retardation film having a relatively thin thickness. However, it may be difficult to control the coating properties of a composition used to prepare the retardation film due to evaporation of a solvent.

Hereinafter, a retardation film according to an embodiment is described.

A retardation film (e.g., a coating-type retardation film) according to an embodiment may include a retardation coating layer prepared by a solution coating process. The retardation coating layer may be, for example, a non-elongated thin film.

The retardation coating layer may have, for example a thickness of less than or equal to about 5 μm, for example less than or equal to about 4.8 μm, less than or equal to about 4.5 μm, less than or equal to about 4.3 μm, less than or equal to about 4.2 μm, less than or equal to about 4.1 μm, less than or equal to about 4.0 μm, less than or equal to about 3.8 μm, or less than or equal to about 3.5 μm. The retardation coating layer may have, for example, a thickness of about 0.1 μm to about 5.0 μm, about 0.1 μm to about 4.8 μm, about 0.1 μm to about 4.5 μm, about 0.1 μm to about 4.3 μm, about 0.1 μm to about 4.2 μm, about 0.1 μm to about 4.1 μm, about 0.1 μm to about 4.0 μm, about 0.1 μm to about 3.8 μm, or about 0.1 μm to about 3.5 μm.

The retardation coating layer may be formed from a liquid coating composition including at least one non-liquid crystal polymer and at least one solvent. As the liquid coating composition is coated and dried by the solution coating process, a considerable amount of solvent may be removed from the liquid coating composition to provide the resulting retardation coating layer, however, a predetermined amount of the solvent may still remain in the retardation coating layer.

The non-liquid crystal polymer may include a heat resistant polymer.

The heat resistant polymer may have for example a glass transition temperature (Tg) of greater than or equal to about 150° C., for example greater than or equal to about 180° C., greater than or equal to about 200° C., greater than or equal to about 220° C., or greater than or equal to about 230° C.

For example, the non-liquid crystal polymer may include a polyimide.

The polyimide may include an imide structural unit, for example, a structural unit represented by Chemical Formula 1.

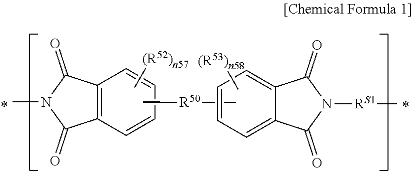

In Chemical Formula 1,

R⁵⁰ may be the same or different in each repeating structural unit and may independently be a single bond, a substituted or unsubstituted C1 to C30 aliphatic group, a substituted or unsubstituted C3 to C30 alicyclic group, a substituted or unsubstituted C6 to C30 aromatic group, or a substituted or unsubstituted C2 to C30 heterocyclic group, R⁵¹ may be the same or different in each repeating unit and may independently be a substituted or unsubstituted C6 to C30 aromatic group, wherein the aromatic group is present alone; two or more aromatic groups linked together to form a condensed ring; or two or more aromatic groups linked together by a single bond, a substituted or unsubstituted fluorenyl group, O, S, C(═O), CH(OH), S(═O)₂, Si(CH₃)₂, (CH₂)ₚ₁ (wherein, 1≤q1≤10), C(CH₃)₂, C(CF₃)₂, or C(═O)NH,

R⁵² and R⁵³ may independently be a substituted or unsubstituted C1 to C30 alkyl group, a substituted or unsubstituted C3 to C30 cycloalkyl group, a substituted or unsubstituted C1 to C30 alkoxy group, a substituted or unsubstituted C6 to C30 aryl group, a substituted or unsubstituted C3 to C30 heterocyclic group, a halogen, a hydroxy group, or a substituted or unsubstituted silyl group, and

n57 and n58 may independently be an integer of 0 to 3.

For example, the structural unit represented by Chemical Formula 1 may include a structural unit represented by Chemical Formula 1a, a structural unit represented by Chemical Formula 1b, or a combination thereof, but is not limited thereto.

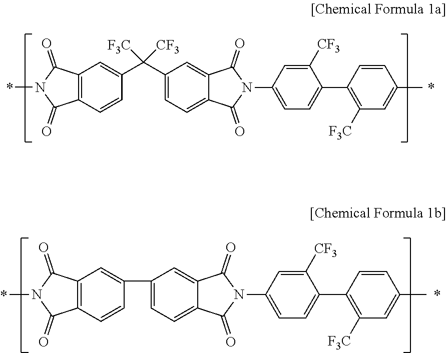

For example, the polyimide may have a weight average molecular weight of about 10,000 Daltons to about 100,000 Daltons.

The polyimide may be obtained, for example, by reacting an anhydride and a diamine compound. For example, the anhydride may be tetracarboxylic acid dianhydride, and the tetracarboxylic acid dianhydride may include for example 3,3′,4,4′-biphenyltetracarboxylic dianhydride (BPDA), 4,4′-(hexafluoroisopropylidene)diphthalic anhydride (6FDA), or a combination thereof and the diamine compound may include for example 2,2′-bis(trifluoromethyl)benzidine (TFDB).

The solvent may be selected from those capable of dissolving the non-liquid crystal polymer such as the polyimide and may include, for example one or more type of the solvent.

Herein, the coating properties of the retardation coating layer may be determined according to a degree of interaction between the non-liquid crystalline polymer such as polyimide and the solvent, and such an interaction may be determined based upon the vapor pressure and the solubility parameter of the solvent.

The solubility parameter may be for example represented by a Hansen solubility parameter. The Hansen solubility parameter may takes into consideration the non-polar dispersion, polarity, and hydrogen bonding present in a given compound and may be represented by the following general formula.

δ_{T}=\sqrt{δ_{D}²+δ_{P}²+δ_{H}²} [General Formula]

In the general formula,

δ_{T} is a total Hansen solubility parameter of a solvent,

δ_{D} is a Hansen solubility parameter of a non-polar dispersion bond of a solvent,

δ_{P} is a Hansen solubility parameter of a polar bond of a solvent, and

δ_{H} is a Hansen solubility parameter of a hydrogen bond of a solvent.

For example, the retardation coating layer may be formed of a liquid coating composition including a polyimide and a solvent, the solvent may have a vapor pressure of less than about 15 Torr at 20° C. and a solubility parameter satisfying Relationship Formula 1.

16≤\sqrt{δ_{D}²+δ_{P}²+δ_{H}²}<20 [Relationship Equation 1]

In Relationship Formula 1,

δ_{D} is a Hansen solubility parameter of a non-polar dispersion bond of the solvent,

δ_{P} is a Hansen solubility parameter of a polar bond of the solvent, and

δ_{H} is a Hansen solubility parameter of a hydrogen bond of the solvent.

The liquid coating composition includes the solvent having both the above-described vapor pressure and solubility parameter, and thereby the solubility and coating properties of the polyimide in the liquid coating composition may be improved to form a retardation coating layer having uniform qualities without staining, even when prepared as a large-area retardation film. Herein, the retardation coating layer with uniform qualities means that the retardation coating layer may exhibit substantially uniform thickness and optical characteristics. For example, a thickness deviation of the retardation coating layer may be less than or equal to about 10 nm, or less than or equal to about 5 nm, or less than or equal to about 1 nm, and a wavelength deviation of the retardation coating layer may be less than or equal to about 3 nm, or less than or equal to about 2 nm, or less than or equal to about 1 nm.

For example, the solvent may have a vapor pressure of about 1 Torr to about 13 Torr at 20° C.

For example, the solvent may have a vapor pressure of about 2 Torr to about 12 Torr at 20° C.

For example, the solvent may have a vapor pressure of about 3 Torr to about 10 Torr at 20° C.

For example, the solvent may have the solubility satisfying Relationship Formula 1 and simultaneously a solubility parameter satisfying Relationship Formula 2.

0<|δ_{P}−δ_{H}|≤4.5 [Relationship Equation 2]

In Relationship Formula 2,

δ_{P} is a Hansen solubility parameter of a polar bond of the solvent, and

δ_{H} is a Hansen solubility parameter of a hydrogen bond of the solvent.

For example, the solvent may have the solubility parameter satisfying Relationship Formula 1 and simultaneously have a solubility parameter satisfying Relationship Formula 3.

9.5≤|δ_{D}−δ_{P}|≤15 [Relationship Equation 3]

In Relationship Formula 3,

δ_{D} is a Hansen solubility parameter of a non-polar dispersion bond of the solvent, and

δ_{P} is a Hansen solubility parameter of a polar bond of the solvent.

For example, the solvent may have the solubility parameter satisfying Relationship Formula 1 and simultaneously have a solubility parameter satisfying Relationship Formula 4.

5.0≤|δ_{D}−δ_{H}|≤15 [Relationship Equation 4]

In Relationship Formula 4,

δ_{D} is a Hansen solubility parameter of a non-polar dispersion bond of the solvent, and

δ_{H} is a Hansen solubility parameter of a hydrogen bond of the solvent.

The polyimide may be present in an amount of greater than or equal to about 3 wt %, or greater than or equal to about 10 wt %, or greater than or equal to about 20 wt %, for example about 3 wt % to about 30 wt %, about 3 wt % to about 25 wt %, about 3 wt % to about 20 wt %, or about 3 wt % to about 18 wt %, based on a total weight of the coating composition.

The retardation film may comprise, consist essentially of, or consist of a retardation coating layer, but is not limited thereto and may further include an additional layer on and/or under the retardation coating layer.

The retardation film may be a transparent film and may have, for example, an average light transmittance of greater than or equal to about 88%, greater than or equal to about 90%, or greater than or equal to about 92%, in a wavelength region of about 360 nm to about 740 nm. The retardation film may have a yellowness index (YI) of less than or equal to about 1.0, less than or equal to about 0.5, or less than or equal to about 0.1, and/or a haze of less than or equal to about 0.3, less than or equal to about 0.2, or less than or equal to about 0.1.

The retardation film may be applied to various display devices.

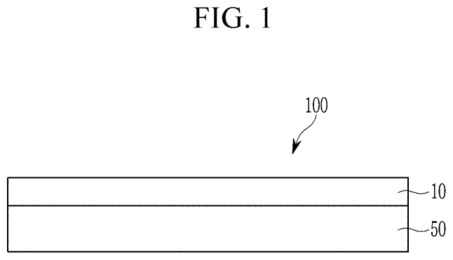

FIG. 1 is a schematic cross-sectional view of a display device according to an embodiment.

Referring to FIG. 1, a display device 100 according to an embodiment includes a display panel 50 and a retardation film 10.

The display panel 50 may be for example a liquid crystal display panel or an organic light emitting display panel.

The retardation film 10 may be disposed on a side closest to an observer.

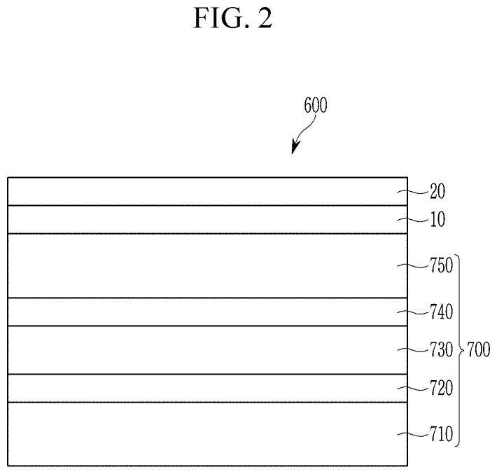

FIG. 2 is a schematic cross-sectional view of an organic light emitting display device according to an embodiment.

Referring to FIG. 2, an organic light emitting display device 600 according to an embodiment includes an organic light emitting display panel 700 and a retardation film 10 disposed on the organic light emitting display panel 700.

The organic light emitting display device 700 may include a base substrate 710, a lower electrode 720, an organic emission layer 730, an upper electrode 740, and an encapsulation substrate 750.

The base substrate 710 may include glass or plastic.

One of the lower electrode 720 and upper electrode 740 may be an anode, and the other one of the lower electrode 720 and upper electrode 740 may be a cathode. The anode is an electrode into which holes are injected and may be made of a conductive material having a high work function, and the cathode is an electrode into which electrons are injected and may be made of a conductive material having a low work function. At least one of the lower electrode 720 and the upper electrode 740 may be made of a transparent conductive material from which light is emitted from the organic light emitting display device to the outside. The transparent conductive material may include, for example indium time oxide (ITO) or indium zinc oxide (IZO).

The organic emission layer 730 includes an organic material which may emit light when a voltage is applied to the lower electrode 720 and the upper electrode 740.

An auxiliary layer (not shown) may be further provided between the lower electrode 720 and the organic emission layer 730 and between the upper electrode 740 and the organic emission layer 730. The auxiliary layer may include a hole transport layer, a hole injection layer, an electron injection layer, and/or an electron transport layer, in order to balance electrons and holes, but is not limited thereto.

The encapsulation substrate 750 may be made of glass, metal, or a polymer, and may seal the lower electrode 720, the organic emission layer 730, and the upper electrode 740 to prevent moisture and/or oxygen inflow from the outside.

The retardation film 10 is the same as previously described and may be disposed at a light emitting side of the organic light emitting display device. For example, in the case of a bottom emission structure emitting light at the side of the base substrate 710, the retardation film 10 may be disposed on the outer surface of the base substrate 710, while on the other hand, in the case of a top emission structure emitting light at the side of the encapsulation substrate 750, the retardation film 10 may be disposed on the outer surface of the encapsulation substrate 750.

A polarizer 20 may be further disposed on the retardation film 10.

The polarizer 20 may face and be in direct contact with the retardation film 10 or may be bonded to the retardation film 10 by an adhesive or a tackifier.

The polarizer 20 may be made of, for example, elongated polyvinyl alcohol (PVA) prepared by, for example, elongating a polyvinyl alcohol film, adsorbing iodine or a dichroic dye thereto, and then, treating with boric acid and washing the same.

The polarizer 20 may be, for example, a polarizing film prepared by melt-blending a polymer and a dichroic dye. In particular, the polarizing film may be, for example, made by mixing a polymer and a dye, melting the mixture at a temperature above the melting point of the polymer, and manufacturing it in a form of a sheet. The polymer resin may be a hydrophobic polymer resin and may be, for example, a polyolefin.

The polarizer 20 may linearly polarize incident light and the retardation film 10 may circularly polarize the linearly polarized light that passes through the polarizer 20.

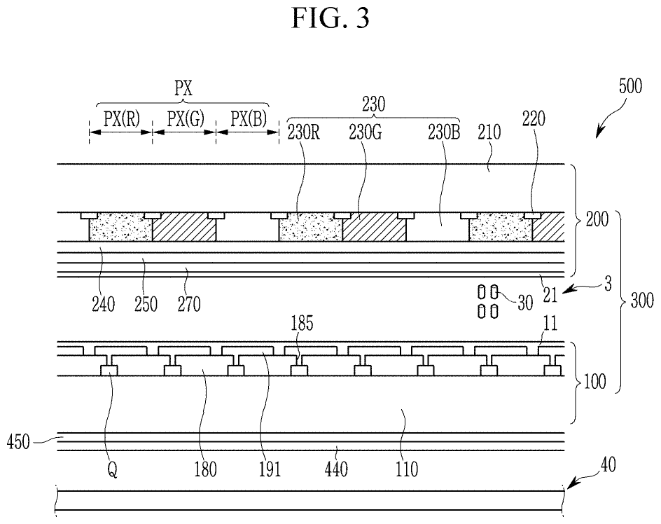

FIG. 3 is a schematic cross-sectional view of a liquid crystal display device according to another embodiment.

Referring to FIG. 3, a liquid crystal display 500 according to an embodiment includes a light source 40 and a liquid crystal display panel 300.

The light source 40 may be a planar light source, a dot light source, a line light source, or a combination thereof, that supplies light to the liquid crystal display panel 300, and may be for example disposed in form of an edge-type or a direct-type. The light source 40 may include a light emitting region (not shown) including a light emitting element, a reflector disposed under the light emitting region and reflecting light emitted from the light emitting region, a light guide panel that supplies the light emitted from the light emitting region toward a liquid crystal display panel and/or at least one optical sheet disposed on the light guide panel, but is not limited thereto.

The light emitting element may be, for example a fluorescent lamp or a light emitting diode (LED), and for example may supply light in a visible wavelength region (hereinafter, referred to as ‘visible light’), for example blue light having high energy.

The liquid crystal display panel 300 includes a lower display panel 100 disposed on the same side as the light source 40, an upper display panel 200 facing the lower display panel 100, and a liquid crystal layer 3 disposed between the lower display panel 100 and the upper display panel 200.

The lower display panel 100 includes a lower substrate 110, a plurality of wires (not shown), a thin film transistor Q, a pixel electrode 191, and an alignment layer 11.

The lower substrate 110 may be, for example, an insulation substrate such as a glass substrate or a polymer substrate, and the polymer substrate may be made of, for example, polyethylene terephthalate, polyethylene naphthalate, polycarbonate, polyacrylate, polyimide, or a combination thereof, but is not limited thereto.

A plurality of gate lines (not shown) that supply a gate signal and a plurality of data lines (not shown) that supply a data signal may be formed while crossing each other on the lower substrate 110, and a plurality of pixels PX disposed in a form of a matrix defined by the gate lines and the data lines.

A plurality of thin film transistors Q is formed on the lower substrate 110. The thin film transistors Q may include a gate electrode (not shown) connected to the gate lines, a semiconductor (not shown) overlapping with the gate electrode, a gate insulating layer (not shown) disposed between the gate electrode and the semiconductor, a source electrode (not shown) connected to the data lines, and a drain electrode (not shown) facing the source electrode in the center of the semiconductor. In FIG. 3, each pixel PX includes one thin film transistor Q, but is not limited thereto, and each pixel may include two or more thin film transistors.

A protective layer 180 is formed on the thin film transistors Q, and a contact hole 185 defined in the protective layer, exposes the thin film transistors Q.

A pixel electrode 191 is formed on the protective layer 180. The pixel electrode 191 may be made of a transparent conductor such as ITO or IZO, and is electrically connected to the thin film transistor Q through the contact hole 185. The pixel electrode 191 may have a predetermined pattern.

An alignment layer 11 is formed on the pixel electrode 191.

The upper display panel 200 includes an upper substrate 210, a color conversion layer 230, an in-cell polarizing layer 240, an in-cell retardation coating layer 250, a common electrode 270, and an alignment layer 21.

The upper substrate 210 may be, for example, an insulation substrate such as a glass substrate or a polymer substrate, and the polymer substrate may be made of, for example polyethylene terephthalate, polyethylene naphthalate, polycarbonate, polyacrylate, polyimide, or a combination thereof, but is not limited thereto.

A light blocking member 220, also referred to as a black matrix, is formed on a surface of the upper substrate 210. The light blocking member 220 may block light leakage between the pixel electrodes 191.

In addition, a color conversion layer 230 is formed on one surface of the upper substrate 210. The color conversion layer 230 receives light having a predetermined wavelength and emits light having the same wavelength or light having a different wavelength region to display colors. The color conversion layer 230 includes a photoluminescent material that is stimulated by light and subsequently emits light by itself, and functions as a light emitting element. The photoluminescent material (e.g., light emitting element) may be, for example at least one of a quantum dot and a phosphor.

For example, the light emitting element may emit light having the same wavelength region as light supplied from the light source 40 or may emit light having a longer wavelength region. For example, when the light source 40 supplies blue light, the light emitting element may emit blue light in the same wavelength region or emit light in a longer wavelength region than the wavelength of blue light, for example red light or green light.

In this way, high photoconversion efficiency and low power consumption may be realized by including the color conversion layer 230 including a light emitting element. In addition, the color conversion layer 230 including the light emitting element may dramatically reduce a light loss according to the amount of light absorption and thus increase photoefficiency compared with a color filter including only a dye and/or a pigment and which absorbs a considerable amount of light emitted from the light source 40, and has low photoefficiency. In addition, color purity may be increased by an inherent luminous color of the light emitting element. Furthermore, the light emitting element emits light scattered in all directions and thus may improve viewing angle characteristics.

FIG. 3 shows a red conversion layer 230R including a red light emitting element emitting red light, a green conversion layer 230G including a green light emitting element emitting green light, and a blue conversion layer 230B including a blue light emitting element emitting blue light, but the present disclosure is not limited thereto. For example, the red conversion layer 230R may emit light in a wavelength region ranging from greater than about 590 nm to less than or equal to about 700 nm, the green conversion layer 230G may emit light in a wavelength region ranging from about 510 nm to about 590 nm, and the blue conversion layer 230B may emit light in a wavelength region ranging from greater than or equal to about 380 nm to less than about 510 nm. For example, the light emitting element may be a light emitting element emitting cyan light, a light emitting element emitting magenta light, and/or a light emitting element emitting yellow light, or may additionally include these light emitting elements. For example, when the light source 40 supplies blue light, the blue conversion layer 230B allows the light supplied from the light source 40 to pass through as is, i.e., without a separate light emitting element, and thus display blue light. Herein, the blue conversion layer 230B may be empty or include a transparent insulator.

The light emitting element may be, for example, at least one of a phosphor and a quantum dot.

For example, the red conversion layer 230R may include a red phosphor, for example at least one of Y₂O₂S:Eu, YVO₄:Eu,Bi, Y₂O₂S:Eu,Bi, SrS:Eu, (Ca,Sr)S:Eu, SrY₂S₄:Eu, CaLa₂S₄:Ce, (Sr,Ca,Ba)₃SiO₅:Eu, (Sr,Ca,Ba)₂Si₅N₈:Eu, or (Ca,Sr)₂AlSiN₃:Eu. For example, the green conversion layer 230G may include a green phosphor, for example at least one of YBO₃:Ce,Tb, BaMgAl₁₀O₁₇:Eu,Mn, (Sr,Ca,Ba)(Al,Ga)₂S₄:Eu, ZnS:Cu,Al Ca₈Mg SiO₄₄Cl₂:Eu, Mn, Ba₂SiO₄:Eu, (Ba,Sr)₂SiO₄:Eu, Ba₂(Mg,Zn)Si₂O₇:Eu, (Ba,Sr)Al₂O₄:Eu, Sr₂Si₃O₈.2SrCl₂:Eu, (Sr,Ca,Ba,Mg)P₂O₇N₈:Eu, Mn, (Sr,Ca,Ba,Mg)₃P₂O₈:Eu,Mn, Ca₃Sc₂Si₃O₁₂:Ce, CaSc₂O₄:Ce, b-SiAlON:Eu, Ln₂Si₃O₃N₄:Tb, or (Sr,Ca, Ba)Si₂O₂N₂:Eu.

For example, the red conversion layer 230 may include a quantum dot. The quantum dot may be a semiconductor nanocrystal as a general concept, and may have various shapes, for example an isotropic semiconductor nanocrystal, a quantum rod, and a quantum plate. Herein, the quantum rod refers to a quantum dot having an aspect ratio of greater than about 1, for example an aspect ratio of greater than or equal to about 2, greater than or equal to about 3, or greater than or equal to about 5. For example, the quantum rod may have an aspect ratio of less than or equal to about 50, of less than or equal to about 30, or of less than or equal to about 20. The quantum dot may have, for example, a particle diameter (an average particle diameter for a non-spherical shape) of about 1 nm to about 100 nm, for example about 1 nm to about 80 nm, for example about 1 nm to about 50 nm, for example about 1 nm to about 20 nm.

The quantum dot may control a light emitting wavelength by changing a size and/or a composition of the quantum dot. For example, the quantum dot may include a Group II-VI compound, a Group III-V compound, a Group IV-VI compound, a Group VI compound, or a combination thereof.

The Group II-VI compound may include, for example, a binary element compound including CdSe, CdTe, ZnS, ZnSe, ZnTe, ZnO, HgS, HgSe, HgTe, MgSe, MgS, or a combination thereof; a ternary element compound including CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, or a combination thereof; and/or a quaternary element compound including HgZnTeS, CdZnSeS, CdZnSeTe, CdZnSTe, CdHgSeS, CdHgSeTe, CdHgSTe, HgZnSeS, HgZnSeTe, HgZnSTe, or a combination thereof.

The Group III-V compound may include a binary element compound including GaN, GaP, GaAs, GaSb, AlN, AlP, AlAs, AlSb, InN, InP, InAs, InSb, or a combination thereof; a ternary element compound including GaNP, GaNAs, GaNSb, GaPAs, GaPSb, AlNP, AlNAs, AlNSb, AlPAs, AlPSb, InNP, InNAs, InNSb, InPAs, InPSb, GaAlNP, or a combination thereof; and/or a quaternary element compound including GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, or a combination thereof.

The Group IV-VI compound may include a binary element compound including SnS, SnSe, SnTe, PbS, PbSe, PbTe, or a combination thereof; a ternary element compound including SnSeS, SnSeTe, SnSTe, PbSeS, PbSeTe, PbSTe, SnPbS, SnPbSe, SnPbTe, or a combination thereof; and/or a quaternary element compound including SnPbSSe, SnPbSeTe, SnPbSTe, or a combination thereof.

The Group IV compound may include a single-element compound selected from Si, Ge, or a combination thereof; or a binary element compound selected from SiC, SiGe, or a combination thereof.

A combination comprising at least one of the foregoing quantum dots may also be used.

The quantum dot may include the binary element compound, the ternary element compound, or the quaternary element compound in a substantially uniform concentration or in partially different concentration distributions.

The quantum dot may have a core-shell structure wherein one quantum dot surrounds another quantum dot. For example, the core and the shell of the quantum dot may have an interface, and an element of at least one of the core or the shell at the interface may have a concentration gradient in which the concentration of the element(s) of the shell decreases from the interface toward the core. For example, a composition of the shell of the quantum dot has a higher energy bandgap than a composition of the core of the quantum dot, and thereby the quantum dot may exhibit a quantum confinement effect. The quantum dot may have a single core and multiple (e.g., two or more) shells surrounding the core. The multi-shell structure has at least two shells wherein each shell may include a single composition, an alloy thereof, and/or may have a concentration gradient. For example, a first shell of a multi-shell structure that is further away from the core may have a higher energy bandgap than a second shell that is closer to the core, and thereby the quantum dot may exhibit a quantum confinement effect.

The quantum dot may have a quantum yield of greater than or equal to about 10%, for example greater than or equal to about 30%, greater than or equal to about 50%, greater than or equal to about 60%, greater than or equal to about 70%, or greater than or equal to about 90%, but is not limited thereto.

The quantum dot has a relatively narrow light emitting wavelength spectrum. For example, the quantum dot may have a full width at half maximum (FWHM) of a light emitting wavelength spectrum of less than or equal to about 45 nm, for example less than or equal to about 40 nm, or less than or equal to about 30 nm.

The quantum dot may be present in the color conversion layer 230 in a form of a quantum dot-polymer composite, wherein the quantum dot is dispersed in the polymer. The polymer may act as a matrix of the quantum dot-polymer composite, and the type of polymer in the quantum dot-polymer composite is not particularly limited as long as the polymer does not quench the quantum dot. The polymer may be a transparent polymer, including, for example, polyvinylpyrrolidone, polystyrene, polyethylene, polypropylene, polymethyl acrylate, polymethyl methacrylate, polybutyl methacrylate (PBMA), a copolymer thereof, or a combination thereof, but is not limited thereto. The quantum dot-polymer composite may include a single layer or a multi-layer structure.

The upper polarizing layer 240 is disposed on a surface of the color conversion layer 230.

The in-cell polarizing layer 240 may be a polarization layer inside of the liquid crystal display panel 300 and may be disposed on a lower surface of the color conversion layer 230. For example, the polarization layer may be disposed on the entire lower surface of the color conversion layer 230. The in-cell polarizing layer 240 may be disposed under the color conversion layer 230 and supplies polarized light with the color conversion layer 230.

In this way, when the in-cell polarizing layer 240 is disposed beneath the color conversion layer 230, and a separate polarizing plate attached outside of the liquid crystal display panel 300 is not present, light emitted from the light emitting element of the color conversion layer 230 is not influenced by the polarizing plate on the outside of the liquid crystal display panel 300, and as a result, a contrast ratio may be improved. Specifically, the light emitting element of the color conversion layer 230 emits scattered light in which polarization is broken, and accordingly, when a polarizing plate is disposed on the color conversion layer 230, that is, where the scattered light passes, black luminance may be increased and thus a contrast ratio may be lowered. In addition, an effect of improving a viewing angle of a liquid crystal display (LCD) may not be hindered by the scattered light emitted from the light emitting element of the color conversion layer 230, but may instead be maintained.

Accordingly, discoloration or image distortion of light emitted from the light emitting element, due to the influence of a polarizing plate attached to the outside surface of a liquid crystal display panel, may be prevented by using the in-cell polarizing layer 240. Furthermore, inherent photoluminescence characteristics of the light emitting element may be maintained, and thus high color purity may be secured and light loss may be reduced. In addition, the in-cell polarizing layer 240 is a thin film having a thickness of less than or equal to about 1 μm, and thus may reduce a total thickness of a liquid crystal display.

The in-cell polarizing layer 240 may be a linear polarizer that converts light emitted from the light source 40 and passed through the liquid crystal layer 3 into linear polarized light.

The in-cell polarizing layer 240 may include, for example, elongated (stretched) polyvinyl alcohol (PVA) prepared according to a method of, for example, elongating (stretching) a polyvinyl alcohol film, adsorbing iodine, or a dichroic dye thereto, treating with boric acid, and washing the same.

For example, the in-cell polarizing layer 240 may be a polarizing film prepared, for example, by mixing a polymer and a dichroic dye and melt blending the polymer with the dichroic dye at a temperature above the melting point of the polymer. The polymer may be a hydrophobic polymer, for example, a polyolefin.

For example, the in-cell polarizing layer 240 may be a wire grid polarizer. The wire grid polarizer has a structure in which a plurality of metal wires are aligned in a single direction, and accordingly, when incident light passes through the wire grid polarizer, light parallel to a metal wire is absorbed or reflected, but light perpendicular thereto is transmitted in the form of linear polarized light. Herein, the linear polarized light may be more efficiently formed when a wavelength of the light is greater than a width of a gap between the metal wires. The wire grid polarizer may be appropriately applied as the in-cell polarizing layer, and since the wire grid polarizer is relatively thin, it can be effectively applied to a thin liquid crystal display 500.

The in-cell retardation coating layer 250 is formed on a surface of the in-cell polarizing layer 240.

The in-cell retardation coating layer 250 may be inside of the liquid crystal display panel 300, and for example, the in-cell retardation coating layer 250 may contact the in-cell polarizing layer 240. For example, the in-cell retardation coating layer 250 may be spaced apart from the in-cell polarizing layer 240 by disposing another layer therebetween, for example, an insulation layer. The insulation layer may include a material such as silicon oxide, nitrogen oxide, or a combination thereof.

The in-cell retardation coating layer 250 may be the same as the retardation film.

The in-cell retardation coating layer 250 may be a coating-type retardation film prepared by coating a solution, as previously described. For example, a liquid coating composition including a non-liquid crystal polymer and a solvent may be prepared, coated and dried, and a predetermined retardation may be imparted thereto by inducing a linear alignment or a planar alignment of the non-liquid crystal polymer during the drying step.

The in-cell retardation coating layer 250 may be formed from a liquid coating composition including a polyimide and a solvent as described above. The coating properties of the polyimide may be improved by selecting a solvent that satisfies the predetermined vapor pressure and solubility parameters described above. Accordingly, even when the large-area in-cell retardation coating layer 250 is used, it is possible to perform a function of a good compensation film without the occurrence of spots due to non-uniform coating of the in-cell retardation coating layer 250.

The in-cell retardation coating layer 250 may have, for example a thickness of less than or equal to about 5 μm, for example less than or equal to about 4.5 μm, less than or equal to about 4.2 μm, less than or equal to about 4.0 μm, less than or equal to about 3.8 μm, less than or equal to about 3.5 μm, less than or equal to about 3.3 μm, less than or equal to about 3.2 μm, or less than or equal to about 3.0 μm. The in-cell retardation coating layer 250 may have, for example, a thickness of about 0.1 μm to about 5.0 μm, about 0.1 μm to about 4.8 μm, about 0.1 μm to about 4.5 μm, about 0.1 μm to about 4.3 about μm, about 0.1 μm to about 4.2 μm, about 0.1 μm to about 4.1 μm, about 0.1 μm to about 4.0 μm, about 0.1 μm to about 3.8 μm, or about 0.1 μm to about 3.5 μm.

The in-cell retardation coating layer 250 may be a transparent film and may have, for example, an average light transmittance of greater than or equal to about 88%, greater than or equal to about 90%, or greater than or equal to about 92%, in a wavelength region of about 360 nm to about 740 nm. The in-cell retardation coating layer may have a yellowness index (YI) of less than or equal to about 1.0, less than or equal to about 0.5, or less than or equal to about 0.1, and/or a haze of less than or equal to about 0.3, less than or equal to about 0.2, or less than or equal to about 0.1.

The common electrode 270 is formed on a surface of the in-cell retardation coating layer 250. The common electrode 270 may include, for example, a transparent conductor such as ITO or IZO and may be formed on an entire surface of the in-cell retardation coating layer 250. The common electrode 270 has a predetermined pattern.

The alignment layer 21 is coated on a surface of the common electrode 270.

The liquid crystal layer 3 including a plurality of liquid crystal molecules 30, is disposed between the lower display panel 100 and the upper display panel 200. The liquid crystal molecule 30 may have positive or negative dielectric anisotropy. For example, the liquid crystal molecule 30 may have negative dielectric anisotropy. For example, the liquid crystal molecule 30 may be aligned in a substantially vertical direction relative to the surface of the substrates 110 and 210 when an electric field is not applied to the pixel electrode 191 and the common electrode 270. Thereby the liquid crystal display 500 may realize a vertical alignment liquid crystal display.

A lower polarization layer 440 and a lower retardation film 450 may be further included under the liquid crystal display panel 300.

The lower polarizing layer 440 is attached to an outer surface of the lower display panel 100. The lower polarizing layer 440 may be a linear polarizer and is configured to polarize light supplied from the light source 40 and to supply polarized light to the liquid crystal layer 3.

For example, the lower polarizing layer 440 may include, for example, elongated polyvinyl alcohol (PVA) prepared according to a method of, for example, elongating a polyvinyl alcohol film, adsorbing iodine or a dichroic dye thereto, treating with borate, and washing the same.

For example, the lower polarizing layer 440 may be a polarizing film prepared, for example, by mixing a polymer and a dichroic dye and melt blending the polymer with the dichroic dye at a temperature above the melting point of the polymer. The polymer may be a hydrophobic polymer, for example, polyolefin.

For example, the lower polarizing layer 440 may be a wire grid polarizer. The wire grid polarizer is combined with the in-cell polarizing layer 240 to realize a thin liquid crystal display (LCD) 500.

The lower retardation film 450 may be attached to an outer surface of the lower display panel 100 and disposed between the lower display panel 100 and the lower polarization layer 440. The lower retardation film 450 may include a single layer or two or more layers.

According to the embodiment, a liquid crystal display (LCD) displays a color by including a color conversion layer including a light emitting element, and thus may have increased photoefficiency and improved color characteristics. In addition, the photo characteristics and color characteristics of the liquid crystal display may be prevented from degeneration by omitting a polarizer and a phase difference film on the outside of an upper substrate. In addition, display characteristics may be improved by securing the photo characteristics and the viewing angle characteristics of the liquid crystal display due to the inclusion of a light emitting element in the color conversion layer. In addition, a thin liquid crystal display device may be realized without deteriorating the display quality by uniformly coating the in-cell retardation coating layer having a thin thickness.

Hereinafter, the embodiments are illustrated in more detail with reference to examples. However, these examples are exemplary, and the present disclosure is not limited thereto.

### Synthesis Example: Synthesis of Polyimide

A reactor connected with a temperature controller is maintained at 25° C., while nitrogen flows therein. 1600 grams (g) of dimethylacetamide (DMAc) and 174 g of 2,2′-bis(trifluoromethyl)benzidine (TFDB) are placed therein and stirred for 1 hour to prepare a diamine solution. 32 g of biphenyl dianhydride (BPDA) and 194 g of 4,4′-(hexafluoroisopropylidene) diphthalic anhydride (6FDA) are added to the diamine solution, and the mixture is stirred at 25° C. for 48 hours to obtain a polyamic acid solution. 167 g of acetic anhydride is added to the polyamic acid solution, and the obtained mixture is stirred for 30 minutes. Subsequently, 129 g of pyridine is added thereto, and the obtained mixture is stirred for 24 hours to obtain a composition including an imidized polymer.

The composition in a solution state is treated with 8 liters (L) of water, and a solid precipitated therein is filtered and pulverized, additionally washed, filtered and pulverized again, and dried at 100° C. in a vacuum oven to obtain a polyimide solid powder.

### Preparation Example: Preparation of Retardation Film

### Preparation Example 1

The polyimide according to the Synthesis Example is dissolved at a concentration of 18 wt % in methyl isoamyl ketone (MIAK) to prepare a liquid coating composition.

Subsequently, the liquid coating composition is spin-coated (700 rpm, seconds), dried on a hot plate at 80° C. for 10 minutes to evaporate a solvent to a degree, and the obtained film was heat-treated in an 180° C. furnace for 60 minutes to obtain a retardation film.

### Preparation Example 2

A retardation film is formed according to the same method as in Preparation Example 1 except that isobutyl isobutyrate (IBIB) is used instead of the methyl isoamyl ketone.

### Preparation Example 3

A retardation film is formed according to the same method as in Preparation Example 1 except that n-butyl propionate is used instead of the methyl isoamyl ketone.

### Preparation Example 4

A retardation film is formed according to the same method as in Preparation Example 1 except that butyl acetate is used instead of the methyl isoamyl ketone.

### Preparation Example 5

A retardation film is formed according to the same method as in Preparation Example 1 except that methyl n-amyl ketone is used instead of the methyl isoamyl ketone.

### Preparation Example 6

A retardation film is formed according to the same method as in Preparation Example 1 except that 1-methoxy-2-propyl acetate instead of the methyl isoamyl ketone is used.

### Comparative Preparation Example 1

A retardation film is formed according to the same method as in Preparation Example 1 except that methyl isobutyl ketone is used instead of the methyl isoamyl ketone.

### Comparative Preparation Example 2

A retardation film is formed according to the same method as in Preparation Example 1 except that isopropyl acetate is used instead of the methyl isoamyl ketone.

### Comparative Preparation Example 3

A retardation film is formed according to the same method as in Preparation Example 1 except that methyl isopropyl ketone is used instead of the methyl isoamyl ketone.

### Comparative Preparation Example 4

A retardation film is formed according to the same method as in Preparation Example 1 except that propyl acetate is used instead of the methyl isoamyl ketone.

### Comparative Preparation Example 5

A retardation film is formed according to the same method as in Preparation Example 1 except that 1-methoxy-2-propanol is used instead of the methyl isoamyl ketone is used.

### Comparative Preparation Example 6

A retardation film is formed according to the same method as in Preparation Example 1 except that cyclopentanone is used instead of the methyl isoamyl ketone.

### Comparative Preparation Example 7

A retardation film is formed according to the same method as in Preparation Example 1 except that N,N-dimethyl acetamide is used instead of the methyl isoamyl ketone.

### Comparative Preparation Example 8

A retardation film is formed according to the same method as in Preparation Example 1 except that N-methyl-2-pyrrolidone is used instead of the methyl isoamyl ketone.

### Comparative Preparation Example 9

A retardation film is formed according to the same method as in Preparation Example 1 except that methylethylketone is used instead of the methyl isoamyl ketone.

### Comparative Preparation Example 10

A retardation film is formed according to the same method as in Preparation Example 1 except that acetone is used instead of the methyl isoamyl ketone.

### Evaluation I

Vapor pressures and solubility parameters of the solvents used in the Preparation Examples and Comparative Preparation Examples, and the thicknesses of the retardation films according to the Preparation Examples and Comparative Preparation Examples, are shown in Table 1.

TABLE 1

| | Solubility parameter | | | | Vapor | Thick- |
|---|---|---|---|---|---|---|
| | (MPa^{1/2}) | | | | pressure | ness |
| | δ_{D} | δ_{P} | δ_{H} | δ_{T} | (Torr) | (μm) |
| Preparation Example 1 | 15.5 | 5.7 | 4.1 | 17 | 4.5 | 3.46 |
| Preparation Example 2 | 15.1 | 2.9 | 5.9 | 16.6 | 3.2 | 2.96 |
| Preparation Example 3 | 15.3 | 3.3 | 6.8 | 17.6 | 3.0 | 3.26 |
| Preparation Example 4 | 15.8 | 3.7 | 6.3 | 17.4 | 10 | 4.11 |
| Preparation Example 5 | 16.2 | 5.7 | 4.1 | 17.6 | 2.14 | 3.49 |
| Preparation Example 6 | 15.5 | 5.5 | 9.8 | 19.2 | 3.75 | 3.33 |
| Comparative Preparation | 15.3 | 6.1 | 4.1 | 17 | 15 | 3.77 |
| Example 1 | | | | | | |
| Comparative Preparation | 14.9 | 4.5 | 8.2 | 17.6 | 47.5 | 5.91 |
| Example 2 | | | | | | |
| Comparative Preparation | 15.5 | 6.8 | 4.1 | 17.4 | 42 | 4.43 |
| Example 3 | | | | | | |
| Comparative Preparation | 15.3 | 4.3 | 7.6 | 17.6 | 23 | NG |
| Example 4 | | | | | | |
| Comparative Preparation | 15.6 | 6.3 | 11.6 | 20.4 | 12.3 | NG |
| Example 5 | | | | | | |
| Comparative Preparation | 17.9 | 11.9 | 5.2 | 22.1 | 11.4 | 4.78 |
| Example 6 | | | | | | |
| Comparative Preparation | 16.8 | 11.5 | 10.2 | 22.8 | 2.48 | 4.6 |
| Example 7 | | | | | | |
| Comparative Preparation | 18 | 12.3 | 7.2 | 23 | 0.29 | 4.57 |
| Example 8 | | | | | | |
| Comparative Preparation | 16 | 9 | 5.1 | 19.1 | 90.6 | 3.96 |
| Example 9 | | | | | | |
| Comparative Preparation | 15.5 | 10.4 | 7 | 19.9 | 231 | NG |
| Example 10 | | | | | | |

δ_{T} = \sqrt{δ_{D}² + δ_{P}² + δ_{H}²}
δ: a total Hansen solubility parameter of a solvent
δ_{D}: a Hansen solubility parameter for a non-polar dispersion bond of a solvent
δ_{P}: a Hansen solubility parameter for a polar bond of a solvent
δ_{H}: a Hansen solubility parameter for a hydrogen bond of a solvent
NG: immeasurable due to cloudiness or non-uniform appearance

### Evaluation II

Spot tests conducted by reflection of the retardation films according to the Preparation Examples and Comparative Preparation Examples is performed.

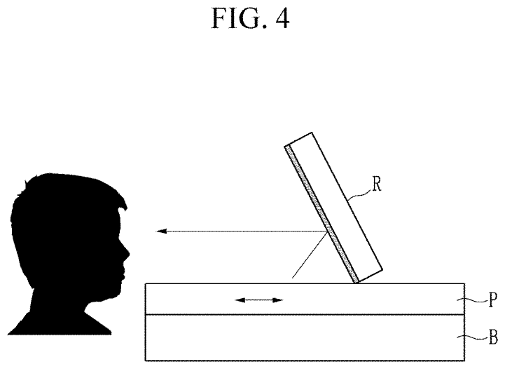

The spot tests by reflection are performed according to the method shown in FIG. 4.

FIG. 4 is a schematic view showing an example of a method for confirming reflection spots in the retardations films according to Preparation Examples and Comparative Preparation Examples.

In FIG. 4, a polarization film (P) (Samsung SDI Co., Ltd.) is overlapped on a backlight (B) (CCFL Light Viewer PB-CANVAS), and a retardation film (R) is tilted at an angle of 70 to 80° to visually evaluate a degree of a spot(s) reflected on the retardation film (R).

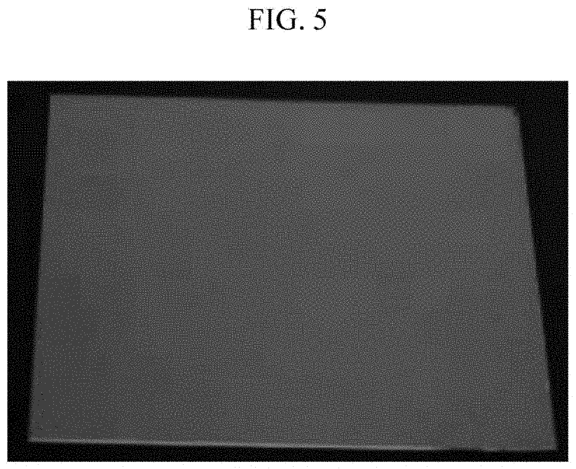

The results are shown in Table 2 and in FIGS. 5 to 7.

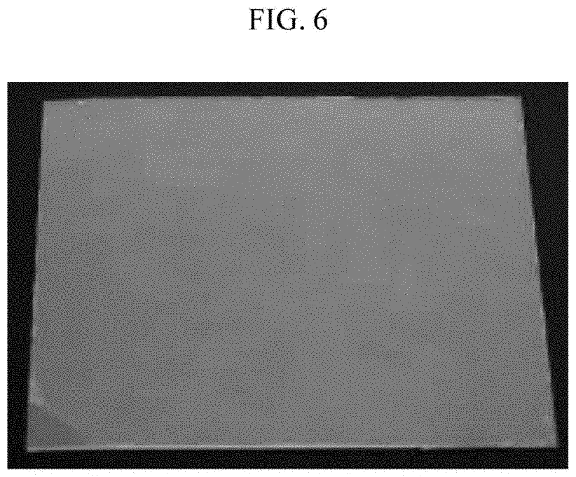

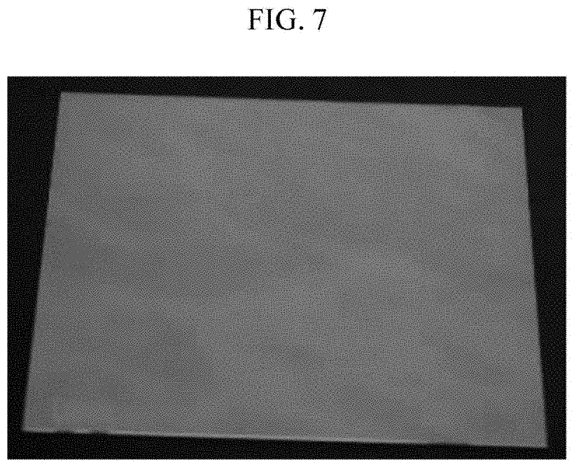

FIG. 5 is a photograph showing the result of a spot test performed by reflection of the retardation film according to Preparation Example 1, FIG. 6 is a photograph showing the result of a spot test performed by reflection of the retardation film according to Comparative Preparation Example 1, and FIG. 7 is a photograph showing the result of performed spot test performed by reflection of the retardation film according to Comparative Preparation Example 6.

TABLE 2

| | Spot or not |
|---|---|
| Preparation Example 1 | X |
| Preparation Example 2 | X |
| Preparation Example 3 | X |
| Preparation Example 4 | X |
| Preparation Example 5 | X |
| Preparation Example 6 | X |
| Comparative Preparation Example 1 | ◯ |
| Comparative Preparation Example 2 | ⊚ |
| Comparative Preparation Example 3 | ⊚ |
| Comparative Preparation Example 4 | ⊚ |
| Comparative Preparation Example 5 | ⊚ |
| Comparative Preparation Example 6 | ⊚ |
| Comparative Preparation Example 7 | ◯ |
| Comparative Preparation Example 8 | ◯ |
| Comparative Preparation Example 9 | ⊚ |
| Comparative Preparation Example 10 | ⊚ |

* ⊚: strong spot, ◯: weak spot, X: no spot.

Referring to FIGS. 5 to 7 and Table 2, the retardation films according to the Preparation Examples show excellent coating properties and thus no spots were observed, however, the retardation films according to the Comparative Preparation Examples showed spots. Accordingly, the retardation films according to the Preparation Examples have excellent coating properties compared with the retardation films according to the Comparative Preparation Examples.

### Evaluation III

Uniformity of the retardation films according to Preparation Examples and Comparative Preparation Examples is evaluated.

The uniformity of the retardation films is evaluated by thickness uniformity and optical property uniformity. More specifically, the thickness uniformity is evaluated by measuring the thickness of the retardation film (F20-UV, Filmetrics Inc.) at various places therein, calculating an average thickness, and calculating a thickness deviation based on the average thickness. The optical property uniformity is evaluated by using an Ellipsometer (EC-400, J. A. Woollam Co.). The optical property uniformity is evaluated as Δλ, which is obtained by dividing a difference of a reflection waveform (at an incident angle of 65°) measured by Ellipsometer, that is, a maximum wavelength difference of the reflection waveform depending on a measurement area around a wavelength of 400 nm, by ¼ of the wavelength.

The results are shown in Table 3.

TABLE 3

| | *Δd (nm) | **Δλ (nm) |
|---|---|---|
| Preparation Example 1 | 2.0 | <1 |
| Preparation Example 2 | 2.0 | <1 |
| Preparation Example 3 | 4.0 | 1.7 |
| Preparation Example 4 | 10.0 | 2.2 |
| Preparation Example 5 | 10.0 | 2.1 |
| Preparation Example 6 | 10.0 | 2.5 |
| Comparative Preparation Example 1 | 46.2 | 6.8 |
| Comparative Preparation Example 2 | ***NG | NG |
| Comparative Preparation Example 3 | 97.6 | 13.9 |
| Comparative Preparation Example 4 | NG | NG |
| Comparative Preparation Example 5 | NG | NG |
| Comparative Preparation Example 6 | 98.3 | 14 |
| Comparative Preparation Example 7 | 69.3 | 10 |
| Comparative Preparation Example 8 | 69.3 | 10 |
| Comparative Preparation Example 9 | NG | NG |
| Comparative Preparation Example 10 | NG | NG |

*Δd: thickness deviation
**Δλ: optical property deviation
***NG: immeasurable due to cloudiness or non-uniform appearance

Referring to Table 3, the retardation films of the Preparation Examples show a small thickness deviation and a small optical property deviation compared with the retardation films according to Comparative Preparation Examples. Accordingly, the retardation films according to Preparation Examples turn out to be uniformly formed compared with the retardation films according to Comparative Preparation Examples.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A retardation film comprising:
a retardation coating layer comprising
polyimide; and
a solvent,
wherein the solvent has a vapor pressure of less than about 15 Torr at 20° C. and a solubility parameter satisfying Relationship Formula 1:
16≤\sqrt{δ_{D}²+δ_{P}²+δ_{H}²}<20 [Relationship Equation 1]
wherein, in Relationship Formula 1,
δ_{D} is a Hansen solubility parameter of a non-polar dispersion bond of the solvent,
δ_{P} is a Hansen solubility parameter of a polar bond of the solvent, and
δ_{H} is a Hansen solubility parameter of a hydrogen bond of the solvent.

2. The retardation film of claim 1, wherein the solvent has a solubility parameter satisfying Relationship Formula 2:
0<|δ_{P}−δ_{H}|≤4.5 [Relationship Equation 2]
wherein, in Relationship Formula 2,
δ_{P} is a Hansen solubility parameter of a polar bond of the solvent, and
δ_{H} is a Hansen solubility parameter of a hydrogen bond of the solvent.

3. The retardation film of claim 1, wherein the solvent has a solubility parameter satisfying Relationship Formula 3:
9.5≤|δ_{D}−δ_{P}|≤15 [Relationship Equation 3]
wherein, in Relationship Formula 3,
δ_{D} is a Hansen solubility parameter of a non-polar dispersion bond of a solvent, and
δ_{P} is a Hansen solubility parameter of a polar bond of a solvent.

4. The retardation film of claim 1, wherein the solvent has a solubility parameter satisfying Relationship Formula 4:
5.0≤|δ_{D}−δ_{H}|≤15 [Relationship Equation 4]
wherein, in Relationship Formula 4,
δ_{D} is a Hansen solubility parameter of a non-polar dispersion bond of a solvent, and
δ_{H} is a Hansen solubility parameter of a hydrogen bond of a solvent.

5. The retardation film of claim 1, wherein a vapor pressure of the solvent is about 3 Torr to about 10 Torr at 20° C.

6. The retardation film of claim 1, wherein a thickness deviation of the retardation coating layer is less than or equal to about 10 nanometers and
a wavelength deviation of the retardation coating layer is less than or equal to about 3 nanometers.

7. The retardation film of claim 1, wherein a thickness of the retardation coating layer is less than or equal to about 5 micrometers.

8. A display device comprising the retardation film of claim 1.

9. A liquid crystal display, comprising
a light source; and
a liquid crystal display panel,
wherein the liquid crystal display panel comprises
a first substrate disposed on the light source,
a second substrate facing the first substrate,
a liquid crystal layer between the first substrate and the second substrate, and
a retardation coating layer between the second substrate and the liquid crystal layer, and comprising polyimide and a solvent,
wherein the solvent has a vapor pressure of less than about 15 Torr at 20° C. and a solubility parameter satisfying Relationship Formula 1:
16≤\sqrt{δ_{D}²+δ_{P}²+δ_{H}²}<20 [Relationship Equation 1]
wherein, in Relationship Formula 1,
δ_{D} is a Hansen solubility parameter of a non-polar dispersion bond of the solvent,
δ_{P} is a Hansen solubility parameter of a polar bond of the solvent, and
δ_{H} is a Hansen solubility parameter of a hydrogen bond of the solvent.

10. The liquid crystal display of claim 9, wherein the solvent has a solubility parameter satisfying Relationship Formula 2:
0<|δ_{P}−δ_{H}|≤4.5 [Relationship Equation 2]
wherein, in Relationship Formula 2,
δ_{P} is a Hansen solubility parameter of a polar bond of the solvent, and
δ_{H} is a Hansen solubility parameter of a hydrogen bond of the solvent.

11. The liquid crystal display of claim 9, wherein the solvent has a solubility parameter satisfying Relationship Formula 3:
9.5≤|δ_{D}−δ_{P}|≤15 [Relationship Equation 3]
wherein, in Relationship Formula 3,
δ_{D} is a Hansen solubility parameter of a non-polar dispersion bond of the solvent, and
δ_{P} is a Hansen solubility parameter of a polar bond of the solvent.

12. The liquid crystal display of claim 9, wherein the solvent has a solubility parameter satisfying Relationship Formula 4:
5.0≤|δ_{D}−δ_{H}|≤15 [Relationship Equation 4]
wherein, in Relationship Formula 4,
δ_{D} is a Hansen solubility parameter of a non-polar dispersion bond of the solvent, and
δ_{H} is a Hansen solubility parameter of a hydrogen bond of the solvent.

13. The liquid crystal display of claim 9, wherein a vapor pressure of the solvent is about 3 Torr to about 10 Torr at 20° C.

14. The liquid crystal display of claim 9, wherein a thickness deviation of the retardation coating layer is less than or equal to about 10 nanometers and
a wavelength deviation of the retardation coating layer is less than or equal to about 3 nanometers.

15. The liquid crystal display of claim 9, wherein a thickness of the retardation coating layer is less than or equal to about 5 micrometers.

16. The liquid crystal display of claim 9, further comprising a polarization layer disposed on or under the retardation coating layer.

17. The liquid crystal display of claim 9, further comprising a color conversion layer on an upper surface the retardation coating layer,
wherein the color conversion layer comprises a light emitting element configured to receive first visible light from the light source and to emit second visible light having the same wavelength as the first visible light or a longer wavelength than the first visible light.

18. A liquid coating composition, comprising
a polyimide; and
a solvent,
wherein the solvent has a vapor pressure of less than about 15 Torr at 20° C. and a solubility parameter satisfying Relationship Formula 1:
16≤\sqrt{δ_{D}²+δ_{P}²+δ_{H}²}<20 [Relationship Equation 1]
wherein, in Relationship Formula 1,
δ_{D} is a Hansen solubility parameter of a non-polar dispersion bond of the solvent,
δ_{P} is a Hansen solubility parameter of a polar bond of the solvent, and
δ_{H} is a Hansen solubility parameter of a hydrogen bond of the solvent.

19. The coating composition of claim 18, wherein the solvent has a solubility parameter satisfying Relationship Formulae 2, 3, and 4:
0<|δ_{P}−δ_{H}|≤4.5 [Relationship Equation 2]
9.5≤|δ_{D}−δ_{P}|≤15 [Relationship Equation 3]
5.0≤|δ_{D}−δ_{H}|≤15 [Relationship Equation 4]
wherein, in Relationship Formulae 2, 3, and 4,
δ_{D} is a Hansen solubility parameter of a non-polar dispersion bond of the solvent,
δ_{P} is a Hansen solubility parameter of a polar bond of the solvent, and
δ_{H} is a Hansen solubility parameter of a hydrogen bond of the solvent.

20. The coating composition of claim 18, wherein the polyimide is present in an amount of about 3 weight percent to about 30 weight percent, based on a total weight of the coating composition.
